(19) United States
(12) Patent Application Publication
(10) Pub. No.: US 2013/0299288 A1
(43) Pub. Date: Nov. 14, 2013

(54) ELECTRONIC DISC BRAKE

(71) Applicants: Dong Yo Ryu, Seoul (KR); I Jin Yang, Seongnam-si (KR); Seong Ho Choi, Anyang-si (KR); Jong Gu Son, Seoul (KR)

(72) Inventors: Dong Yo Ryu, Seoul (KR); I Jin Yang, Seongnam-si (KR); Seong Ho Choi, Anyang-si (KR); Jong Gu Son, Seoul (KR)

(21) Appl. No.: 13/892,154

(22) Filed: May 10, 2013

(30) Foreign Application Priority Data
May 11, 2012 (KR) 10-2012-0049985

(51) Int. Cl. F16D 55/226

(52) U.S. Cl. CPC F16D 55/226
USPC 188/72.4

(57) ABSTRACT

Disclosed herein is an electronic disc brake. The electronic disc brake includes a carrier on which a pair of pad plates are mounted, a caliper housing, which is slidably installed on the carrier and is provided with a cylinder having a piston mounted therein, a pressure device installed within the cylinder, the pressure device converting rotational motion into rectilinear motion to press and release the piston, the pressure device having an output key which protrudes by penetrating a rear wall of the caliper housing, a motor mounted on an outer surface of the caliper housing to generate drive force, a reducer coupled with a rotary shaft of the motor to amplify the drive force, and a coupling interposed between the reducer and the pressure device to transmit the amplified drive force to the pressure device, wherein the motor, the reducer, and the pressure device are coaxially connected in series.

### CROSS-REFERENCE TO RELATED APPLICATION

This application claims the benefit of Korean Patent Application No. 2012-0049985, filed on May 11, 2012 in the Korean Intellectual Property Office, the disclosure of which is incorporated herein by reference.

### BACKGROUND

1. Field

Embodiments of the present invention relate to an electronic disc brake capable of simplifying a coupling structure which transmits rotation torque together with drive force of a motor to a gear portion in a serial manner.

2. Description of the Related Art

In general, parking brake devices are devices to stop vehicles so as not to move when the vehicles are parked, and serve to hold wheels of the vehicles so as not to rotate.

Recently, there is used an EPB (electronic parking brake) system to electronically control operation of a parking brake. Such an EPB system is mounted on a typical disc brake and performs a parking brake function. Here, EPB systems are classified into a cable puller type, a motor-on-caliper type, and a hydraulic parking brake type.

FIG. 1 is a view schematically illustrating a conventional electronic disc brake. The electronic disc brake shown in FIG. 1 is of a motor-on-caliper type.

Referring to FIG. 1, the electronic disc brake 1 includes a disc D which rotates together with a wheel (not shown) of a vehicle, a carrier 10 which is provided with a pair of pad plates 11 and 12 disposed at both sides of the disc D so as to press the disc D, a caliper housing 20 which is slidably installed on the carrier 10 and is equipped with a piston 21 movably mounted therein to press the pair of pad plates 11 and 12, a motor 60 to generate drive force, a reducer 40 to amplify the drive force generated by the motor 60, a gear assembly 50 to transmit the drive force of the motor 60 to the reducer 40, and a pressure device 30 to transmit rotational force of the motor 60 from the reducer 40 to the piston 21.

The pair of pad plates 11 and 12 are classified into an inner pad plate 11 adjacent to the piston 21 and an outer pad plate 12 located opposite the inner pad plate 11.

The caliper housing 20 is provided, at one side thereof, with a cylinder 23, and the piston 21 pressing the inner pad plate 11 against the disc D is mounted in the cylinder 23. The other side of the caliper housing 20 is provided with a finger portion 22, which is bent downwards and connected integrally with the cylinder 23, so that the finger portion 22 presses the outer pad plate 12 against the disc D along with sliding of the caliper housing 20.

The carrier 10 is fixed to a vehicle body and guides the pair of pad plates 11 and 12 so as to move forwards or backwards toward or away from the disc D without separation of the pair of pad plates 11 and 12.

The piston 21 presses the inner pad plate 11 against the disc D while rectilinearly reciprocating through driving of the motor 60, during a braking operation. Drive force of the motor 60 is transmitted through the gear assembly 50 to the reducer 40, and is then transmitted to the piston 21 through the pressure device 30 in a state in which the drive force is amplified by the reducer 40.

The pressure device 30 serves to press the piston 21 against the inner pad plate 11, as described above. Such a pressure device 30 includes a spindle member 35, which is screw-coupled to a rotary shaft of a carrier 47 of the reducer 40 to be described later and receives rotational force of the motor 60, and a nut member 31 which is screw-coupled to the spindle member 35 to press the piston 21. In this case, a bearing 25 to support the spindle member 35 is installed within the cylinder 23.

The gear assembly 50 includes a drive gear 51 installed on a shaft 61 of the motor 60, a driven gear 54 connected to the reducer 40, and a pinion idle gear 52 connecting the drive gear 51 and the driven gear 54. That is, rotational force generated along with rotation of the shaft 61 of the motor 60 is transmitted to the driven gear 54 through the pinion idle gear 52 engaged between the drive gear 51 and the driven gear 54.

The reducer 40 is formed of a 2-stage planetary gear type. That is, the reducer 40 includes a first reduction unit, a second reduction unit, and an internal gear 44.

The first reduction unit includes a first sun gear 41 installed at a central shaft 53 of the driven gear 54, a plurality of first planetary gears 42 arranged around the first sun gear 41 so as to be engaged with the first sun gear 41, and a first carrier 43 connected to shafts 42a of the first planetary gears 42.

The second reduction unit has the same structure as the first reduction unit. That is, the second reduction unit includes a second sun gear 45 installed at a rotary shaft of the first carrier 43, a plurality of second planetary gears 46 arranged around the second sun gear 45 so as to be engaged with the second sun gear 45, and a second carrier 47 connected to shafts 46a of the second planetary gears 46. A rotary shaft of the second carrier 47 is connected to the pressure device 30. Here, the first and second planetary gears 42 and 46 are engaged with the internal gear 44 fixed at the outside thereof.

That is, in the above-mentioned electronic disc brake 1, rotational force generated by the operation of the motor 60 is transmitted through the gear assembly 50 to the reducer 40, with the consequence that, when the first sun gear 41 rotates, the first planetary gears 42 engaged to the fixed internal gear 44 revolve and revolution of the first planetary gears 42 is transmitted through the first carrier 43 to the second reduction unit. Furthermore, the second reduction unit transmits rotational force to the spindle member 35 through the same action as the first reduction unit, thereby allowing the spindle member 35 to rotate at reduced speed. When the spindle member 35 rotates, the nut member 31 axially moves and presses the piston 21, to thereby perform braking.

However, the above-mentioned electronic disc brake 1 has a structure in which drive force of the motor 60 is firstly reduced through the gear assembly 50, and finally is secondarily reduced through the reducer 40 in the form of a 2-stage planetary gear, to generate braking force by converting rotational force into rectilinear force by the pressure device 30, i.e., a U-type power transmission structure. Therefore, if the electronic disc brake is mounted, the sizes of the cylinder 23, the carrier 10, and a power transmission unit (for example, a motor, a gear assembly, and a reducer) are increased, and thus the electronic disc brake 1 may be limited as to installation only in vehicles of a medium size or more.

Furthermore, the electronic disc brake may be disadvantageous in terms of operation noise thereof during braking due to the use of the multistage gears. Accordingly, various research and development to improve utilization of an installation space for an electronic disc brake which is automatically operated using a motor or to reduce operation noise of the electronic disc brake have been carried out.

### SUMMARY

Therefore, it is an aspect of the present invention to provide an electronic disc brake which decreases operation noise and is efficiently operated while having a reduced volume, by improving structures of respective components, such as a motor to generate drive force, gears to transmit the drive force, and a reducer to reduce rotational force, and a connection structure between the components.

Additional aspects of the invention will be set forth in part in the description which follows and, in part, will be obvious from the description, or may be learned by practice of the invention.

In accordance with one aspect of the present invention, an electronic disc brake includes a carrier on which a pair of pad plates are movably mounted, a caliper housing, which is slidably installed on the carrier and is provided with a cylinder having a piston movably mounted therein, a pressure device installed within the cylinder, the pressure device converting rotational motion into rectilinear motion to press and release the piston, the pressure device having an output key which protrudes by penetrating a rear wall of the caliper housing, a motor mounted on an outer surface of the caliper housing to generate drive force, a reducer coupled with a rotary shaft of the motor to amplify the drive force, and a coupling interposed between the reducer and the pressure device to transmit the amplified drive force to the pressure device, wherein the motor, the reducer, and the pressure device are coaxially connected in series.

The motor may include a case formed with an accommodation space therein, a rotor provided within the case, magnets being mounted along an outer peripheral surface of the rotor at a predetermined interval, a rotary shaft being coupled to a center of the rotor, a bearing mounted between the case and the rotary shaft so as to rotatably support the rotary shaft, and a stator, which is spaced apart from the outer peripheral surface of the rotor by a predetermined distance to enclose the rotor and around which coils are wound so as to generate rotational drive force relative to the rotor.

The reducer and the coupling may be accommodated in the accommodation space of the case.

The reducer may include an eccentric member connected to the rotary shaft of the motor to eccentrically transmit rotation thereof, an inner gear in which the eccentric member is mounted to a center thereof such that the inner gear is eccentrically rotated by the eccentric member, and an outer gear having a diameter larger than the inner dear, an inner surface of the outer gear being engaged with an outer surface of the inner gear such that the inner gear rotated by the rotary shaft revolves and rotates.

The reducer may have a tooth shape in which teeth formed on the inner surface of the outer gear are engaged with the teeth formed on the outer surface of the inner gear, and the number of the teeth of the inner gear may be smaller than the number of the teeth of the outer gear.

The outer gear may be fixed to the motor so as to prevent rotation of the outer gear.

The eccentric member may be an eccentric bearing having an eccentric center to which the rotary shaft is coupled.

Another eccentric member according to the present invention may include an eccentric shaft which is eccentric from a center of the rotary shaft, and a coupling bearing having a center to which the eccentric shaft is fitted.

The coupling may have a cylindrical shape of a predetermined thickness, the coupling may be formed, at one surface thereof, with a first coupling groove into which an input key is inserted while being formed, at the other surface thereof, with a second coupling groove into which the output key is inserted, and the first and second coupling grooves may be formed in the form of a rectangular slot.

The first and second coupling grooves may be formed perpendicular to each other.

Each of the output key and the input key may have a rectangular shape.

The input key may translate in a length direction of the first coupling groove to transmit rotational torque to the coupling, and the coupling may translate in a length direction of the second coupling groove with respect to the output key to transmit only rotational torque to the output key.

The pressure device may include a spindle member having one side portion, which is located within the cylinder and is formed, at an outer peripheral surface thereof, with threads, and the other side portion in which the output key is formed at a tip portion defined by penetrating the rear wall of the caliper housing, and a nut member, which is screw-coupled to the spindle member and moves forwards and backwards depending on rotation of the spindle member to press and release the piston.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view illustrating a conventional electronic disc brake;

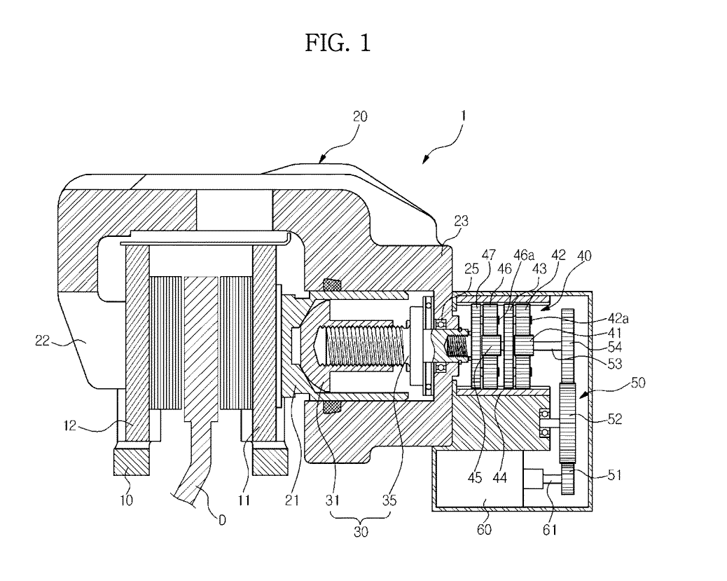

FIG. 2 is a cross-sectional view illustrating an electronic disc brake according to an embodiment of the present invention;

FIG. 3 is an exploded perspective view illustrating a reducer provided in the electronic disc brake according to the embodiment of the present invention;

FIG. 4 is an exploded perspective view illustrating another form of a reducer provided in the electronic disc brake according to the embodiment of the present invention;

FIG. 5 is a perspective view illustrating a coupling provided in the electronic disc brake according to the embodiment of the present invention; and

FIG. 6 is a reference view for explaining a state in which rotational torque is transmitted by the coupling of the electronic disc brake according to the embodiment of the present invention.

### DETAILED DESCRIPTION

Reference will now be made in detail to the embodiments of the present invention, examples of which are illustrated in the accompanying drawings, wherein like reference numerals refer to like elements throughout.

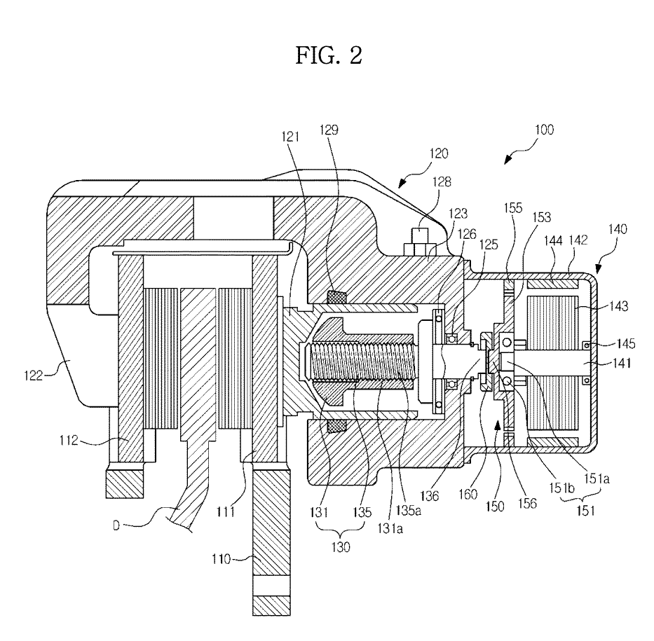

FIG. 2 is a cross-sectional view schematically illustrating a configuration of an electronic disc brake according to an embodiment of the present invention.

Referring to FIG. 2, the electronic disc brake 100 includes a disc D which rotates together with a wheel (not shown) of a vehicle, a carrier 110 which is provided with a pair of pad plates 111 and 112 disposed so as to press both side surfaces of the disc D to perform braking, a caliper housing 120 equipped with a piston 121 which is movably mounted therein to press the pair of pad plates 111 and 112, a pressure device 130 which converts rotational force into rectilinear reciprocating motion to press the piston 121, a motor 140 to generate drive force, a reducer 150 connected to the motor 140, and a coupling 160 which is interposed between the reducer 150 and the pressure device 130 to transmit the amplified drive force to the pressure device.

The pair of pad plates 111 and 112 are classified into an inner pad plate 111 disposed to abut against the piston 121 and an outer pad plate 112 disposed to abut against a finger portion 122 to be described later. The pair of pad plates 111 and 112 are movably mounted on the carrier 110 fixed to a vehicle body so as to move forwards or backwards toward or away from both side surfaces of the disc D. The caliper housing 120 is also mounted on the carrier 110 so as to be slidable in a direction of pressing the pair of pad plates 111 and 112.

The caliper housing 120 is provided, at the rear thereof, with a cylinder 123 equipped with the piston 121. The finger portion 122, which is bent downwards to operate the outer pad plate 112, is provided at the front of the caliper housing 120 and is formed integrally with the cylinder 123.

The piston 121 is formed in a cylindrical shape, the inside of which is indented like a cup, and is inserted into the cylinder 123 so as to be slidable. This piston 121 presses the inner pad plate 111 against the disc D by axial force of the pressure device 130 receiving rotational force of the motor 140.

Meanwhile, the caliper housing 120 is formed with an oil port 128 through brake oil is introduced such that hydraulic pressure for braking is applied within the cylinder 123. A sealing member 129 to prevent leakage of oil is arranged between an outer surface of the piston 121 and an inner surface of the cylinder 123.

Accordingly, when the hydraulic pressure for braking is applied within the cylinder 123, the piston 121 moves forwards toward the inner pad plate 111 to press the inner pad plate 111, and the caliper housing 120 moves in a direction opposite the piston 121 so that the finger portion 122 presses the outer pad plate 112, thereby enabling braking of the disc D to be performed.

In the electronic disc brake 100 according to the embodiment of the present invention, a parking function by braking of the disc D may be realized for the purpose of parking.

The pressure device 130 serves to press the piston 121 against the inner pad plate 111, as described above, and is arranged within the cylinder 123. Such a pressure device 130 includes a nut member 131 formed with a female threaded portion 131a on an inner surface thereof, and a spindle member 135 formed with a male threaded portion 135a which is screw-coupled to the female threaded portion 131a of the nut member 131.

The spindle member 135 penetrates the cylinder 123, and is rotatably arranged within the cylinder 123 in parallel with a direction in which the nut member 131 moves forwards and backwards. In this case, the other side of the spindle member 135, namely, a tip portion of the spindle member 125, which protrudes by penetrating the cylinder 123, is formed with an output key 136 coupled to the coupling 160 to be described later. The output key 136 has a rectangular shape, and receives rotational force through the coupling 160. This will be described again in detail below.

In order to support the spindle member 135, the cylinder 123 is provided with a first bearing 125 and a second bearing 126 which are spaced apart from each other. Here, the second bearing 126 is a thrust bearing, and receives reaction force, which is generated in the direction in which the nut member 131 moves forwards and backwards during braking and is transmitted through the spindle member 135. The nut member 131 is arranged in a contact state with the piston 121.

The motor 140 is an electric motor which includes a rotor 143 to rotate a rotary shaft 141 and a stator 144, and generates drive force to rotate the spindle member 135 of the pressure device 130. This motor 140 includes a case 142 formed with an accommodation space therein, a rotor 143 which is arranged within the case 142, in which a plurality of magnets (not shown) are mounted to annular yokes at a predetermined interval along an outer peripheral surface of the rotor, and which is coupled, at the center thereof, with a rotary shaft 141, a bearing 145 which is mounted between the case 142 and the rotary shaft 141 so as to rotatably support the rotary shaft 141, and a stator 144 which is spaced apart from the outer peripheral surface of the rotor 143 by a predetermined distance to enclose the rotor 143 and around which coils (not shown) are wound so as to generate rotational drive force relative to the rotor 143. When power is applied to the coils of the stator 144, repulsive force and attractive force act between the magnets and the coils, so that the rotary shaft 141 rotates together with the rotor 143.

Meanwhile, the motor 140 is connected to an ECU (electronic control unit; not shown) to control the motor 140, and thus operation of the motor 140 is controlled. For example, the ECU controls various operations of the motor 140, such as driving, stoppage, normal rotation, and reverse rotation of the motor 140, through input signals transmitted according to driver's instructions. When brake operating instructions or brake releasing instructions is applied to the ECU by a driver, the ECU causes the motor 140 to rotate in a normal direction or a reverse direction. Furthermore, the ECU may include a count sensor to measure an RPM of the motor 140 or a current sensor to sense an amount of current, and control the motor 140 based on the RPM or the amount of current sensed by the count sensor or the current sensor. Since controlling the motor 140 through the ECU is well known in the art, a detailed description will be omitted.

Such a motor 140 is installed on a rear wall of the caliper housing 120, together with the reducer 150 and the coupling 160 to be described later, which are received in the accommodation space of the case 142.

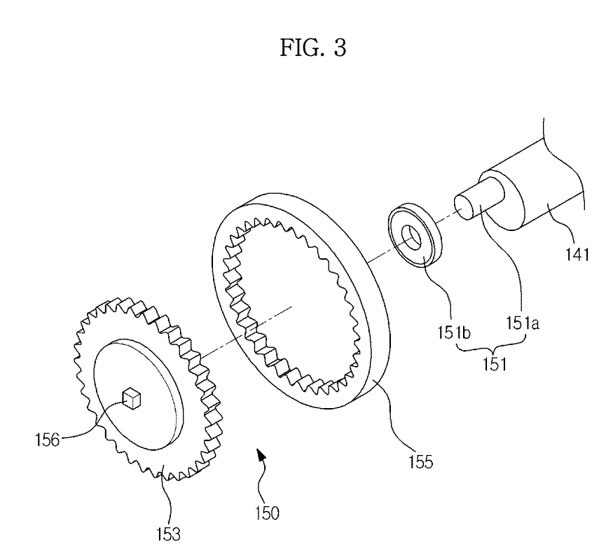

The reducer 150 is connected to the rotary shaft 141 to amplify drive force of the motor, and a configuration thereof is shown in FIG. 3.

Referring FIGS. 2 and 3, the reducer 150 includes an eccentric member 151 which is connected to the rotary shaft 141 of the motor 140 to eccentrically transmit rotation thereof, an inner gear 153 in which the eccentric member 151 is mounted to a center thereof such that inner gear 153 is eccentrically rotated by the eccentric member 151, and an outer gear 155 which is engaged with an outer peripheral surface of the inner gear 153 such that the inner gear 153 revolves and rotates.

In accordance with the embodiment of the present invention, the eccentric member 151 includes an eccentric shaft 151a which is eccentric from the center of the rotary shaft 141 of the motor 140 such that the inner gear 153 rotates eccentrically, and a coupling bearing 151b having a center to which the eccentric shaft 151a is fitted. That is, when rotational force is transmitted from the rotary shaft 141 of the motor 140, the coupling bearing 151b mounted to the center of the inner gear 153 receives the eccentric rotational force by the eccentric shaft 151a, thereby rotating eccentrically. In this case, the eccentric shaft 151a may be formed integrally with the rotary shaft 141.

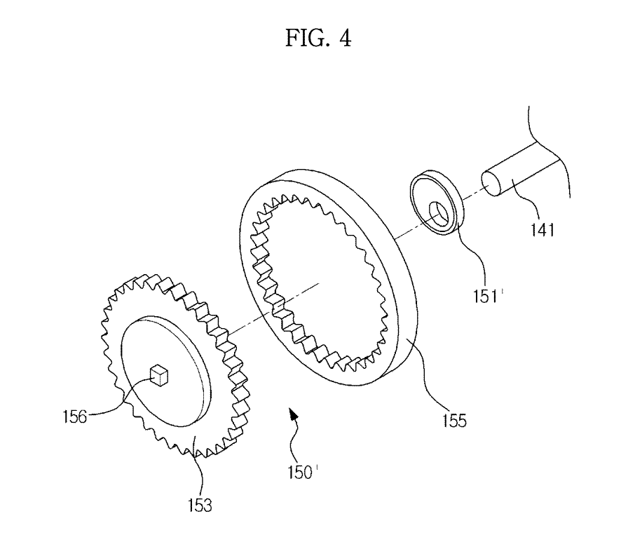

The above eccentric member 151 is an example of a configuration in which rotational force is eccentrically transmitted to eccentrically rotate the inner gear 153, and the embodiment of the present invention is not limited thereto. For example, if the inner gear 153 is configured to rotate eccentrically, any configuration may be provided. As shown in FIG. 4, an eccentric member 151′ of a reducer 150′ according to another embodiment of the present invention is mounted to a center of an inner gear 153, and may be configured of an eccentric bearing 151′ having an off-centered hole into which the rotary shaft 141 of the motor 140 is inserted and coupled. Thus, the inner gear 154 rotates eccentrically by the eccentric bearing 151′ receiving rotational force.

That is, according to the embodiments of the present invention, the inner gear 153 rotates eccentrically by the eccentric member 151 or 151′, and is formed, at the outer peripheral surface thereof, with teeth. As shown in the drawings, the center of the inner gear 153 is provided with an input key 156 which protrudes to be coupled to the coupling 160. The input key 156 has a rectangular shape, and serves to translate and transmit rotational force through the coupling 160. This will be described again in detail below.

The outer gear 155 has a diameter larger than the inner gear 153, and is fixed to the case 142 of the motor 140 so that the outer gear 155 is engaged, at an inner peripheral surface thereof, with the outer peripheral surface of the inner gear to revolve and rotate during eccentric rotation of the inner gear 153. This outer gear 155 has a tooth shape in which teeth formed on the inner peripheral surface of the outer gear are engaged with the teeth formed on the outer peripheral surface of the inner gear. In this case, the number of the teeth of the inner gear 153 is smaller than that of the outer gear 155. Accordingly, the reduction of speed and torque of the motor increase at speed corresponding to a reduction ration generated by a difference between the numbers of the teeth of the inner and outer gears, thereby transmitting rotational force.

In such a reducer 150 or 150′, when the eccentric member 151 or 151′ connected to the rotary shaft 141 of the motor 140 rotates eccentrically, the inner gear 153 rotates depending on the difference between the number of the teeth of the inner gear 153 and the number of the teeth of the outer gear 155 while revolving within the outer gear 155. For example, in the case of rotating the inner gear 153 in a clockwise direction using the eccentric member 151 or 151′, though the inner gear 153 itself revolves in the clockwise direction, the inner gear 153 rotates in a counterclockwise direction along the inner peripheral surface of the outer gear 155 because of engagement with the outer gear 155. That is, since the rotational momentum of the inner gear 153 is an RPM which is reduced and output, the reduced speed is transmitted through the coupling 160 to the spindle member 135.

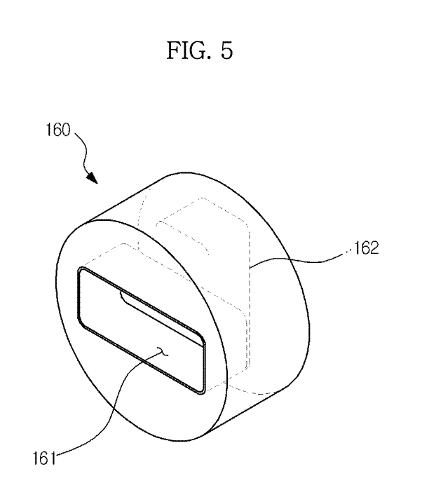

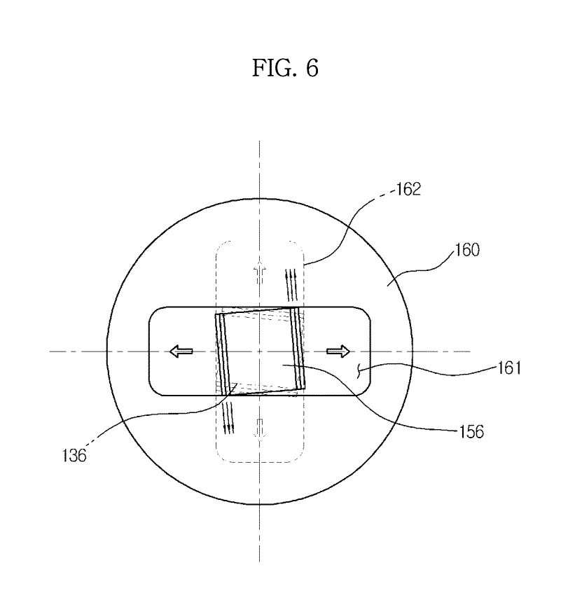

In order to transmit the reduced drive force to the spindle member 135, the coupling 160 according to the present embodiment is provided. As shown in FIG. 5, the coupling 160 has a cylindrical shape of a predetermined thickness, and one surface and the other surface of the coupling 160 are formed with first and second coupling grooves 161 and 162 in the form of a rectangular slot, respectively. In this case, the first and second coupling grooves 161 and 162 are formed perpendicular to each other. In addition, the input key 156 and the output key 136 are inserted into the first and second coupling grooves 161 and 162, respectively. For example, as shown FIG. 2, the input key 156 is inserted into the first coupling groove 161, and the output key 136 is inserted into the second coupling groove 162. The rectangular input key 156 is inserted into the first coupling groove 161 and translates in a length direction of the first coupling groove 161, and the coupling 160 translates in a length direction of the second coupling groove 162 with respect to the output key 136 (see FIG. 6). That is, in order to transmit only rotational force output from the reducer 150 through the coupling 160 to the spindle member 135, each of the first and second coupling grooves 161 and 162 has an elongated hole shape.

In more detail, the following description will be given with respect to an operation state in which the rotational force of the reducer 150 or 150′ is transmitted through the coupling 160 to the spindle member 135.

First, the input key 156 arranged at the center of the revolving and rotating inner gear 153 and the output key 136 of the spindle member 135 are located at the centers, i.e. at the centers of the first and second coupling grooves 161 and 162. Thus, when the inner gear 153 rotates, namely, the input key 156 moves in the length direction of the first coupling groove 161, for example, in the downward direction, the coupling 160 moves in the length direction of the second coupling groove 162 with respect to the output key 136 such that the output key 136 is located in the right direction.

In addition, along with eccentric rotation of the inner gear 153, the input key 156 moves again in the upward direction through the center of the first coupling groove 161, and the coupling 160 moves in the length direction of the second coupling groove 162 with respect to the output key 136 such that the output key 136 is located in the left direction.

According to repetition of the above motion, the input key 156 of the inner gear 153 translates in the length direction of the first coupling groove 161 to transmit rotational torque to the coupling 160, and coupling 160 translates in the length direction of the second coupling groove 162 with respect to the output key 136 to transmit only rotational torque to the output key 136.

Accordingly, it may be possible to rotate the spindle member 135, which receives the rotational force by the coupling 160 coupled between the spindle member 135 and the reducer 150, in the same line as the rotary shaft 141 of the motor 140. Moreover, the pressure device 130, the reducer 150 or 150′, and the motor 140 are connected in series. Therefore, it may be possible to decrease the volume and overall length of the component by reducing the thickness thereof, compared to the assembly of the conventional gears.

Hereinafter, a braking operation of the above electronic disc brake will be described.

First, when a driver of a vehicle pushes a control unit (not shown), for example, a parking switch (not shown) in a state in which two pad plates 111 and 112 are spaced apart from both sides of the disc D, in response to signals of the control unit, the motor 140 rotates to generate drive force. That is, the reducer 150, which receives the rotational force by the rotary shaft 141 of the motor 140, rotates eccentrically and the speed of the reducer is reduced. Consequently, only rotational torque is transmitted to the spindle member 135 by the coupling 160 connected to the reducer 150 or 150′. That is, the spindle member 135 amplifies torque of the motor 140 in proportion to the reduction ratio of the inner gear 153, thereby generating output. Accordingly, when the nut member 131, which is movably mounted to the spindle member 135, moves to press the piston 121, the piston 121 pushes the inner pad plate 111 toward the disc D, and the caliper housing 120 is slid and presses the outer pad plate 112 so as to come into contact with the disc D, thereby allowing braking to be performed.

Meanwhile, as the spindle member 135 rotates in the direction opposite the braking when braking force is released, the nut member 131 is moved to an original position and two pad plates 111 and 112 are returned to an original state while being spaced apart from both sides of the disc D.

Consequently, since a structure in which drive force of the motor 140 is transmitted to the spindle member 135 in a state amplified by the reducer 150 or 150′ is made through the coupling 160 in a serial manner, it may be possible to decrease the overall size of the electronic disc brake, compared to the prior art. Therefore, the electronic disc brake may ensure of ease of installation and improve utilization of an installation space by having reduced weight, thus being easily installed regardless of vehicle capacity. Furthermore, it may be possible to minimize braking noise during braking due to a simple assembly structure made in a serial manner.

As is apparent from the above description, a configuration of an electronic disc brake according to the present invention may be simplified by a single-stage reducer, which allows realization of highly reduced speed, and a coupling to transmit rotational torque.

In addition, the reducer is connected through the coupling with a motor as well as a spindle member in series, thus enabling the overall length of the electronic disc brake to be minimized. The volume of the electronic disc brake may be further decreased by providing the reducer and the coupling within the motor, thereby enabling space utilization to be maximized.

Thereby, the electronic disc brake may provide a compact coupling structure and improve space utilization, thus being installed regardless of vehicle capacity. That is, the electronic disc brake may reduce the sizes (volumes) of unnecessary cylinder and carrier and may thus have reduced weight.

Furthermore, the electronic disc brake may significantly decrease operation noise during braking due to simplification of a gear assembly structure, compared to a conventional multistage gear assembly.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic disc brake for braking of a vehicle, comprising:
a carrier on which a pair of pad plates are movably mounted;
a caliper housing, which is slidably installed on the carrier and is provided with a cylinder having a piston movably mounted therein;
a pressure device installed within the cylinder, the pressure device converting rotational motion into rectilinear motion to press and release the piston, the pressure device having an output key which protrudes by penetrating a rear wall of the caliper housing;
a motor mounted on an outer surface of the caliper housing to generate drive force;
a reducer coupled with a rotary shaft of the motor to amplify the drive force; and
a coupling interposed between the reducer and the pressure device to transmit the amplified drive force to the pressure device,
wherein the motor, the reducer, and the pressure device are coaxially connected in series.

2. The electronic disc brake according to claim 1, wherein the motor comprises:
a case formed with an accommodation space therein;
a rotor provided within the case, magnets being mounted along an outer peripheral surface of the rotor at a predetermined interval, a rotary shaft being coupled to a center of the rotor;
a bearing mounted between the case and the rotary shaft so as to rotatably support the rotary shaft; and
a stator, which is spaced apart from the outer peripheral surface of the rotor by a predetermined distance to enclose the rotor and around which coils are wound so as to generate rotational drive force relative to the rotor.

3. The electronic disc brake according to claim 2, wherein the reducer and the coupling are accommodated in the accommodation space of the case.

4. The electronic disc brake according to claim 1, wherein the reducer comprises:
an eccentric member connected to the rotary shaft of the motor to eccentrically transmit rotation thereof;
an inner gear in which the eccentric member is mounted to a center thereof such that the inner gear is eccentrically rotated by the eccentric member; and
an outer gear having a diameter larger than the inner dear, an inner surface of the outer gear being engaged with an outer surface of the inner gear such that the inner gear rotated by the rotary shaft revolves and rotates.

5. The electronic disc brake according to claim 4, wherein the reducer has a tooth shape in which teeth formed on the inner surface of the outer gear are engaged with the teeth formed on the outer surface of the inner gear, and the number of the teeth of the inner gear is smaller than the number of the teeth of the outer gear.

6. The electronic disc brake according to claim 4, wherein the outer gear is fixed to the motor so as to prevent rotation of the outer gear.

7. The electronic disc brake according to claim 4, wherein the eccentric member is an eccentric bearing having an eccentric center to which the rotary shaft is coupled.

8. The electronic disc brake according to claim 4, wherein the eccentric member comprises an eccentric shaft which is eccentric from a center of the rotary shaft, and a coupling bearing having a center to which the eccentric shaft is fitted.

9. The electronic disc brake according to claim 4, wherein the coupling has a cylindrical shape of a predetermined thickness, the coupling is formed, at one surface thereof, with a first coupling groove into which an input key is inserted while being formed, at the other surface thereof, with a second coupling groove into which the output key is inserted, and the first and second coupling grooves are formed in the form of a rectangular slot.

10. The electronic disc brake according to claim 9, wherein the first and second coupling grooves are formed perpendicular to each other.

11. The electronic disc brake according to claim 10, wherein each of the output key and the input key has a rectangular shape.

12. The electronic disc brake according to claim 11, wherein the input key translates in a length direction of the first coupling groove to transmit rotational torque to the coupling, and the coupling translates in a length direction of the second coupling groove with respect to the output key to transmit only rotational torque to the output key.

13. The electronic disc brake according to claim 1, wherein the pressure device comprises:
a spindle member having one side portion, which is located within the cylinder and is formed, at an outer peripheral surface thereof, with threads, and the other side portion in which the output key is formed at a tip portion defined by penetrating the rear wall of the caliper housing; and
a nut member, which is screw-coupled to the spindle member and moves forwards and backwards depending on rotation of the spindle member to press and release the piston.
